(19) United States
(12) Patent Application Publication
(10) Pub. No.: US 2011/0309991 A1
(43) Pub. Date: Dec. 22, 2011

(54) HIGH EFFICIENCY ANTENNA HAVING COMPACT DIMENSIONS, PARTICULARLY FOR INSTALLATION ON A VEHICLE, SUCH AS AN AIRCRAFT OR A HIGH VELOCITY TRAIN OR A MOTOR VEHICLE

(75) Inventors: Alfredo Catalani, Rome (IT); Pasquale Russo, Rome (IT)

(73) Assignee: SPACE ENGINEERING S.P.A., Rome (IT)

(21) Appl. No.: 13/166,170

(22) Filed: Jun. 22, 2011

Related U.S. Application Data
(63) Continuation-in-part of application No. 12/046,822, filed on Mar. 12, 2008, now abandoned.

(30) Foreign Application Priority Data
Mar. 23, 2007 (IT) RM2007A000154

(51) Int. Cl. H01Q 19/10

(52) U.S. Cl. 343/837

(57) ABSTRACT

This invention is related to a high efficiency antenna having compact dimensions, particularly for installation on a vehicle, such as an aircraft or a high velocity train or a motor vehicle, comprising a main circular reflector, an illuminator or feed, centrally mounted with respect to said main reflector, and a sub-reflector, mounted on said illuminator by means of a positioning support member, said antenna being installed upon a positioning member adapted to carry out azimuth and elevation polarisation movements.

### PRIORITY INFORMATION

The present application is a continuation-in-part application of and claims benefit from U.S. patent application Ser. No. 12/046,822, filed on Mar. 12, 2008, which claims priority to Italian Patent Application No. RM2007A000154, filed on Mar. 23, 2007, both of which are incorporated herein in their entirety.

### BACKGROUND

This invention is related to a high efficiency antenna having compact dimensions, particularly for installation on a vehicle, such as an aircraft or a high velocity train or a motor vehicle.

More particularly, this invention relates to an antenna of the above said type for entertainment applications on vehicles in Ku band.

As it is well known, an ever increasing interest is now dedicated to new entertainment applications, such as television or Internet, to be utilised on moving mass transport means.

At present, all applications of this type utilise geo-stationary satellites operating in Ku band to carry out a transponder function to ground based gateway units.

Obviously, since a service of this kind is intended for use on vehicles, such as aircraft or high velocity trains in which the dimensions are of paramount relevance, it is evidently important that an approach be available as the one proposed by this invention that enables an antenna characterised by minimum dimensions to be achieved.

### SUMMARY

It is an object of this invention to realise an antenna adapted to operate over the whole receiving band ranging from 10.70 GHz to 12.75 GHz as well as over the whole transmission band ranging from 13.75 GHz to 14.50 GHz.

It is a further object of this invention to realise a high efficiency antenna having restricted dimensions so as to make it amenable to be installed on vehicles, such as aircraft, high velocity trains, and like, with minimum effects as to the problems associated with the arrangement of outer devices mounted on the fuselage or on the body of the vehicle, in view of the fact that its overall dimensions are very small and it has an average radiation efficiency of nearly 60%.

These and other advantageous results are achieved according to this invention by proposing an antenna substantially consisting of a double circular reflector of offset type, wholly made of aluminium, realised by means of numerically controlled machines and by utilising an OMT, so that it will be possible to discriminate the Rx band from the Tx band and to simultaneously operate with two linear orthogonal polarisations.

It is specific subject matter of this invention, therefore, to provide a high efficiency antenna, particularly for installation on a vehicle, such as an aircraft or a high velocity train or a motor vehicle, comprising main circular reflector, an illuminator or feed, centrally mounted with respect to the main reflector, a sub-reflector, mounted on the illuminator, and positioning support member suitable to distance the sub-reflector and said illuminator, so that the overall structure is capable to absorb vibrations and shocks, the positioning support member is provided with openings, laterally defined by bars, so as to allow the passage of the electric field between the sub-reflector and the main reflector.

Always according to the invention, the positioning support member could be derived from a single metal element.

Still according to the invention, the bars could have a rhomboidal cross section, so as to reduce the scattering of the electric field.

Further according to the invention, the main reflector could be provided with a central hole having the same dimensions as a lower flange provided in the illuminator, and is further provided with a first spacer ring nut provided on the illuminator, adapted to space it from the main reflector.

Always according to the invention, the sub-reflector could be provided with a second ring nut adapted to space it from the support member.

Still according to the invention, the positioning support member could be realised as a single piece of substantially frustum conic shape, so as to reduce its volumetric dimensions and minimising the secondary lobe of the radiation diagram in the two operation bands Tx and Rx in the main planes at 45° with respect to the planes of the support members.

Further according to the invention, the main reflector is shaped in order to avoid to reflect the electric field in the direction of said sub-reflector.

Always according to the invention, the illuminator could be stepped feed shaped, so as to be able to excite the waveguide illuminator multi-modes for providing correct illumination of the sub-reflector over the complete operative Ku-band.

Still according to the invention, the surfaces of the reflectors could be of the type obtained after an optimisation process based upon dedicated software.

Further according to the invention, the main reflector and the sub-reflector could be of the type realised by means of a two axis milling machine tool or by means of a numerically controlled lathe.

Advantageously according to the invention, the illuminator and the support member could be of the type realised by lathe machining and subsequent refining by grinding machine.

Always according to the invention, the support member could be made of metal, preferably aluminium.

Still according to the invention, the antenna could comprise means to be installed upon a positioning member adapted to carry out azimuth and elevation polarisation movements.

### BRIEF DESCRIPTION OF THE DRAWINGS

This invention will be now described by way of illustration not by way of limitation, according to its preferred embodiments, by particularly referring to the figures of the attached drawings, in which:

FIG. 1 is a perspective view of an antenna according to this invention;

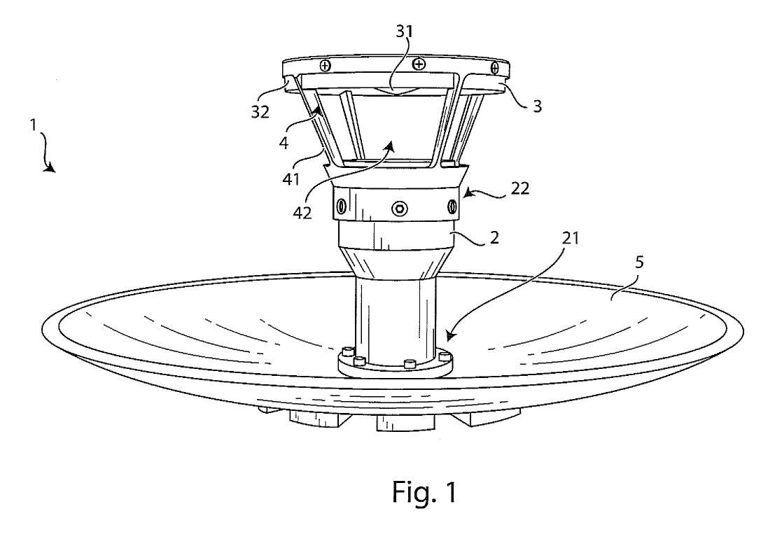

FIG. 2 shows a detail of the antenna of FIG. 1; and

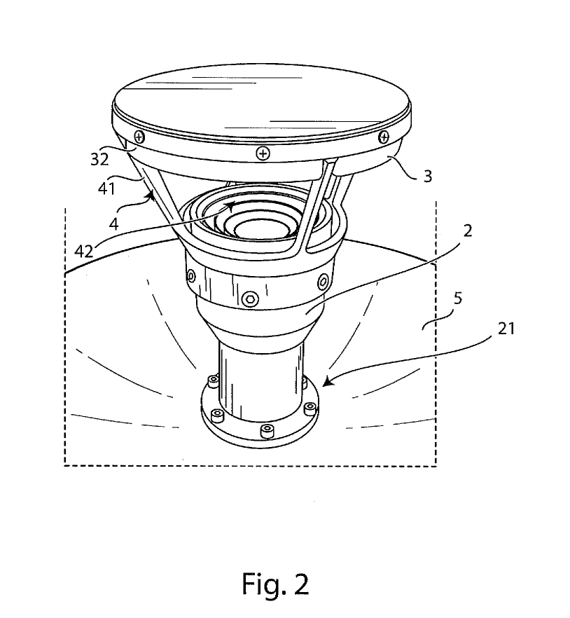

FIG. 3 illustrates the design principle of the antenna according to this invention.

### DETAILED DESCRIPTION OF THE INVENTION

By referring to the Figures of the attached drawings, an antenna according to this invention is shown, generally designated by reference numeral 1, which comprises a broad band illuminator (feed) 2, adapted to operate in Ku band of 10.7 GHz to 14.5 GHz, a circular sub-reflector 3, a metal support member 4, which correctly places sub-reflector 3 with respect to the illuminator 2, as well as circular reflector 5, or main reflector, forming the beam emanating from the antenna.

The positioning support member 4 is derived from a single metal element. Furthermore, said support member is provided with openings 42, laterally defined by bars 41, so as to allow the passage of the electric field between the said sub-reflector 3 and said main reflector 5.

The bars 41 have a rhomboidal cross section. This cross section allows to reduce the degradation of the antenna electrical performances due to the scattering of the electric field, because the particular struts shape is able to redirect a portion of the diffracted energy on the main reflector zones that typically are not fed due to the presence of the same struts that block the direct incident rays.

The support member design takes into account the simplification of the manufacturing but at the same time it guarantees to realize a mechanical support member characterized by the stiffness requested for boarding on high speed vehicles and able to resist the operative mechanical stress maintaining the nominal electrical performances of the antenna.

Moreover, the support member 4, so realized, allows to speed up the assembly procedures, allowing a repeatable process, so as to guarantee always the correct nominal alignment and inter-spacing between the support member and the feed both in quit conditions and operative conditions as well.

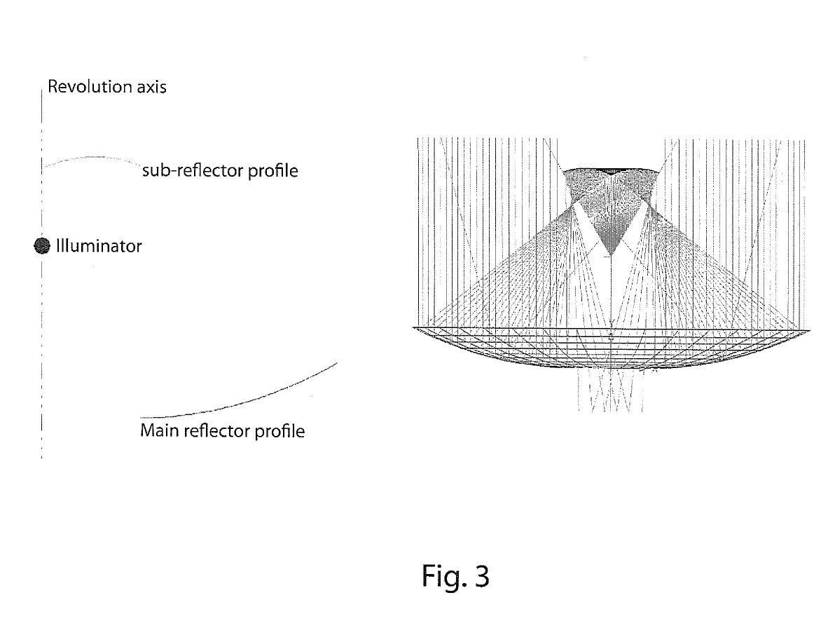

By particularly observing FIG. 3, it is to be noted that the optics of antenna 1 according to the invention is characterised in that it is generated by starting from a cassegrain antenna pattern having a double onset reflector; in a subsequent step, the surfaces of the sub-reflector and of the main reflector have been modified and optimised by means of a dedicated software: such a designing process enables the effects of the reflection of sub-reflector 3 upon the illuminator 2 itself to be mitigated, which effects otherwise would result into degradation of performances when expressed in terms of VSWR and in addition it enables the illumination characteristics of said main reflector 1 upon said sub-reflector 3 to be improved, thereby minimising the spillover losses.

The design of the multi-modal stepped feed horn illuminator 2 provides the correct illumination of the sub-reflector 3.

Furthermore, the design of the shaped sub-reflector 3 has an optimized profile able to minimize the back scattering of the electric field in the feed direction with consequent improving of performances in terms of matching (Return Loss).

In particular, as can be seen from the figures, the sub-reflector 3 is a disc with a centrally arranged cusp 31 and a perimeter circular relief 32. This sub-reflector 3 can illuminate (or be illuminated by) main reflector 5.

Moreover the design of the shaped main reflector 5 avoids to reflect the electric field in the direction of the sub-reflector 3 with a consequent minimization of the blocking and scattering effects.

The antenna 1 comprises even a dedicated metallic support, placed between the feed (the illuminator 2) and the sub-reflector 3, designed for guaranteeing the correct alignment and the correct positioning. This parameter maximizes the electrical performances of the invention.

In the embodiment illustrated in the drawings, an antenna is shown with a main reflector 5, having a disc of 360 mm diameter, a sub-reflector 3, having a disc of 120 mm diameter, with a centrally placed cusp and an illuminator 2 with four axial corrugations and having an aperture of 60 mm diameter.

Antenna 1 according to this invention was developed aiming at reducing the manufacturing costs and in order to achieve very precise alignment characteristics of the optics consisting of illuminator 2 plus sub-reflector 3 plus main reflector 5.

The realisation of main reflector 5 and of sub-reflector 3 can be carried out by means of a double axis milling machine tool or by means of a numerically controlled lathe, while illuminator 2 and support member 4 should be realised by lathe machining.

The illuminator 5 is stepped feed shaped, with an optimized profile that is able to excites the illuminator 2 waveguide multi-modes, so as to provide the correct illumination of the sub-reflector 3 over the complete operative Ku-band and it is manufactured by numerically controlled lathe.

The central hole in main reflector 5, having the same diameter as illuminator 2 on the flange side, assures that said illuminator be centred under extremely high accuracy, while a abutting first spacer ring nut 21 on illuminator 2 assures a correct distance between the mouth of illuminator 2 and the main reflector 5 itself. The first spacer ring nut 21 is adjustable, so as to adjust the distance between the mouth of illuminator 2 and said main reflector 5.

Sub-reflector 3 has an abutting second spacer ring nut 22 to assure its correct distance with respect to main reflector 5 by means of support member 4.

Support member 4 is made of aluminium and it is designed so as to cause a minimum shadowing effect in illumination of sub-reflector 3 on main reflector 5. Furthermore, since it is manufactured starting from a single, very compact, frustum conical piece, its structural strength characteristics as well as its accuracy characteristics in respect of its axial alignment, in addition to the correct distance between illuminator 2 and sub-reflector 3 are guaranteed.

By these means, an antenna 1 can be obtained which is distinctly characterised by high easiness in its assembling steps, having high alignment accuracy in all of its constituent parts and also having high efficiency in its radiation diagrams.

In addition, the provision of support members between sub-reflector 3 and illuminator (feed) 2 enables the antenna itself to be characterised in that the secondary lobe in the radiation diagram in the two operating bands (Tx and Rx) in the main planes (E plane and H plane) displaced at 45 degrees with respect to the planes containing the support members themselves is minimised. The advantage deriving from this feature can be appreciated in the transmission band when applying for the required authorisations from the relevant agencies that define the maximum radiation power limits as expressed by the ETSI rules.

The whole construction of antenna 1 appears to be scarcely affected by possibly present strong vibrations, such as the vibrations detectable on board of aircraft, while the intrinsic electrical performances of the antenna are maintained unaltered.

Antenna 1 according to this invention is designed so as to be installed upon a positioner adapted to carry out the required azimuth, elevation well as polarisation movements, and, as above stated, as a result of a suitable optimisation effort, it has overall dimensions corresponding to the volume of a sphere of 385 cm diameter.

The metallic struts in typical condition brings blocking effects on the electric fields and consequent degradation of the antenna performances in terms of efficiency and side-lobe level of the radiation pattern. This invention provides a solution that allows to be negligible the contribution of the metallic struts presence on the antenna performances.

Moreover, the mechanical realization starting form a single metallic piece is the warrantee that the assembly of all the parts don't need of any operation for electrical tuning refinement (remarkable for mass production) and the electrical performances are aligned with the nominal prediction.

Furthermore, in operative condition, when the invention is installed on high speed trains or aircrafts, the invention exhibits a particular stiffness, characterized by all parts so assembled, that guarantees the electrical performances required.

On the grounds of the preceding discussion, it can be concluded that antenna 1 according to this invention offers the noticeable advantage it turns out to be very compact and therefore it can be very easily installed on aircraft or generally on vehicles, since it minimises the effects of the radome on the aerodynamic performances of the aircraft.

In addition, the electric characteristics of the concerned antenna enable the system to reach adequate performances to realise protocol TCP/IP based connections between aircraft and satellite.

In view of the compactness characteristics, this antenna including its orientation system can be presently installed within a radome certified for flight and owned by Airbus which is being used on aircraft A340-600 but can also be installed on models A350-A380.

The antenna according to the invention is able to achieve the high performances in terms of efficiency (better than 85%) and side-lobe level by the correct alignment and assembling of the optimized parts of the invention over the complete Ku-band that are in term of percentage equal to the 35% of the band.

This invention has been described by way of illustration and not by way of limitation in connection with its preferred embodiments, but it should be understood that variations and/or modifications can be made by those skilled in the art without departing from the scope of this invention, as defined by the following claims.

What is claimed:

1. A high efficiency antenna, particularly for installation on a vehicle, such as an aircraft or a high velocity train or a motor vehicle, comprising
a main circular reflector,
an illuminator or feed, centrally mounted with respect to said main reflector,
a sub-reflector, mounted on said illuminator, and
a positioning support member suitable to distance said sub-reflector and said illuminator, so that the overall structure is capable to absorb vibrations and shocks, said positioning support member is provided with openings, laterally defined by bars, so as to allow the passage of the electric field between the said sub-reflector and said main reflector.

2. An antenna according to claim 1, wherein said positioning support member is derived from a single metal element.

3. An antenna according to claim 1, wherein said bars have a rhomboidal cross section, so as to reduce the scattering of the electric field.

4. An antenna according to claim 1, wherein said main reflector is provided with a central hole having the same dimensions as a lower flange provided in said illuminator, and is further provided with a first spacer ring nut provided on said illuminator, adapted to space it from said main reflector.

5. An antenna according to claim 1, wherein said sub-reflector is provided with a second ring nut adapted to space it from said support member.

6. An antenna according to claim 1, wherein said positioning support member is realised as a single piece of substantially frustum conic shape, so as to reduce its volumetric dimensions and minimising the secondary lobe of the radiation diagram in the two operation bands Tx and Rx in the main planes at 45° with respect to the planes of the support members.

7. An antenna according to claim 1, wherein said main reflector is shaped in order to avoid to reflect the electric field in the direction of said sub-reflector.

8. An antenna according to one of the preceding claims, characterised in that said illuminator is stepped feed shaped, so as to be able to excite the waveguide. illuminator multi-modes for providing correct illumination of the sub-reflector over the complete operative Ku-band.

9. An antenna according to claim 1, wherein the surfaces of the reflectors are of the type obtained after an optimisation process based upon dedicated software.

10. An antenna according to claim 1, wherein said main reflector and said sub-reflector are of the type realised by means of a two axis milling machine tool or by means of a numerically controlled lathe.

11. An antenna according to claim 1, wherein said illuminator and said support member are of the type realised by lathe machining and subsequent refining by grinding machine.

12. An antenna according to claim 1, wherein said support member is made of metal, preferably aluminium.

13. An antenna according to claim 1, wherein said antenna comprises means to be installed upon a positioning member adapted to carry out azimuth and elevation polarisation movements.
